(19) United States
(12) Patent Application Publication
(10) Pub. No.: US 2026/0277248 A1
(43) Pub. Date: Sep. 17, 2026

(54) VEHICLES AND METHODS FOR ROUTING A PLURALITY OF VEHICLES TO A COMMON DESTINATION

(71) Applicant: Toyota Jidosha Kabushiki Kaisha, Toyota-shi (JP)

(72) Inventor: Divya Garikapati, San Jose, CA (US)

(73) Assignee: Toyota Jidosha Kabushiki Kaisha, Toyota-shi (JP)

(21) Appl. No.: 19/076,245

(22) Filed: Mar. 11, 2025

(51) Int. Cl. G05D 1/697; G05D 109/10; G05D 111/30

(52) U.S. Cl. CPC G05D 1/697; G05D 2109/10; G05D 2111/32

(57) ABSTRACT

In one embodiment, a method for routing a plurality of vehicles includes receiving an input from an input device of a vehicle, wherein the input includes a destination location, a destination date and time, and at least one companion vehicle, receiving, by the vehicle, a companion location for the at least one companion vehicle, generating, by the vehicle, a primary vehicle route for the vehicle and a companion vehicle route for the at least one companion vehicle, and transmitting, using a network interface hardware of the vehicle, one or more control signals to the at least one companion vehicle to at least partially control the at least one companion vehicle such that it arrives at the destination location at the destination date and time.

### BACKGROUND

Multiple vehicles of a group often travel to a common destination from multiple origination locations. As an example, a group of individuals arriving at a common destination, such as a leisure destination, from multiple starting locations is often referred to as “caravanning.” The caravan or platoon of vehicles may travel along one or more routes to the common destination. The multiple vehicles may travel on the same road in a line, or may travel along different routes from different origination locations to a common destination. However, it can be difficult to coordinate all of the vehicles of the platoon so that the vehicles arrive in a timely and efficient manner. Additionally, it may be difficult to communicate regarding a change of route, new destinations, etc.

Accordingly, alternative methods for coordinating multiple vehicles to arrive at a common destination may be desired.

### BRIEF SUMMARY

In one embodiment, a vehicle includes an input device, network interface hardware, one or more processors, and a non-transitory memory component. The non-transitory memory component stores instructions that, when executed by the one or more processors, cause the one or more processors to receive an input from the input device, wherein the input includes a destination location, a destination date and time, and at least one companion vehicle, cause the one or more processors to receive a companion location for the at least one companion vehicle, cause the one or more processors to generate a primary vehicle route for the vehicle and a companion vehicle route for the at least one companion vehicle, and cause the one or more processors to transmit, using the network interface hardware, one or more control signals to the at least one companion vehicle to at least partially control the at least one companion vehicle such that it arrives at the destination location at the destination date and time.

In another embodiment, a method for routing a plurality of vehicles includes receiving an input from an input device of a vehicle, wherein the input includes a destination location, a destination date and time, and at least one companion vehicle, receiving, by the vehicle, a companion location for the at least one companion vehicle, generating, by the vehicle, a primary vehicle route for the vehicle and a companion vehicle route for the at least one companion vehicle, and transmitting, using a network interface hardware of the vehicle, one or more control signals to the at least one companion vehicle to at least partially control the at least one companion vehicle such that it arrives at the destination location at the destination date and time.

These and additional features provided by the embodiments described herein will be more fully understood in view of the following detailed description, in conjunction with the drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a vehicle interior with a user interface to coordinate companion vehicles to arrive at a destination at substantially the same date and time according to one or more embodiments described and illustrated herein.

FIG. 2 illustrates a map of a user interface to coordinate companion vehicles to arrive at a destination at substantially the same date and time according to one or more embodiments described and illustrated herein.

FIG. 3 illustrates an example vehicle communicating through a wireless communication network according to one or more embodiments described and illustrated herein.

FIG. 4 illustrates components of a vehicle system for performing functionalities described herein according to one or more embodiments described and illustrated herein.

FIG. 5 illustrates a method for routing a plurality of vehicles according to one or more embodiments described and illustrated herein.

### DETAILED DESCRIPTION

Embodiments of the present disclosure provide systems and methods for coordinating a plurality of vehicles such that they arrive at a destination at the substantially the same time, or achieve some other objective. More particularly, embodiments of the present disclosure enable a primary, lead vehicle to generate routes for a plurality of companion vehicles of a caravan, platoon or other group. In some embodiments, a lead vehicle or remote computing device may provide control signals to the other companion vehicles. The companion vehicles may be manually controlled, semi-autonomously controlled, or autonomously controlled. The vehicles in the caravan, platoon or other group may be traveling to a common location from many individual origination locations.

Embodiments are not limited to having a single common destination. There may be multiple origination locations and multiple destinations. Such cases may have different goals/destinations but a requirement that they be completed at the same time. Example use-cases include fighter planes coordinating to achieving a common goal but not reaching the same destination. As another example, cargo ships may have different start points and destination points while trying to deliver cargo on time at several locations.

Various embodiments of vehicles, systems and methods for controlling a plurality of vehicles for coordination of arriving at a destination are described in detail below.

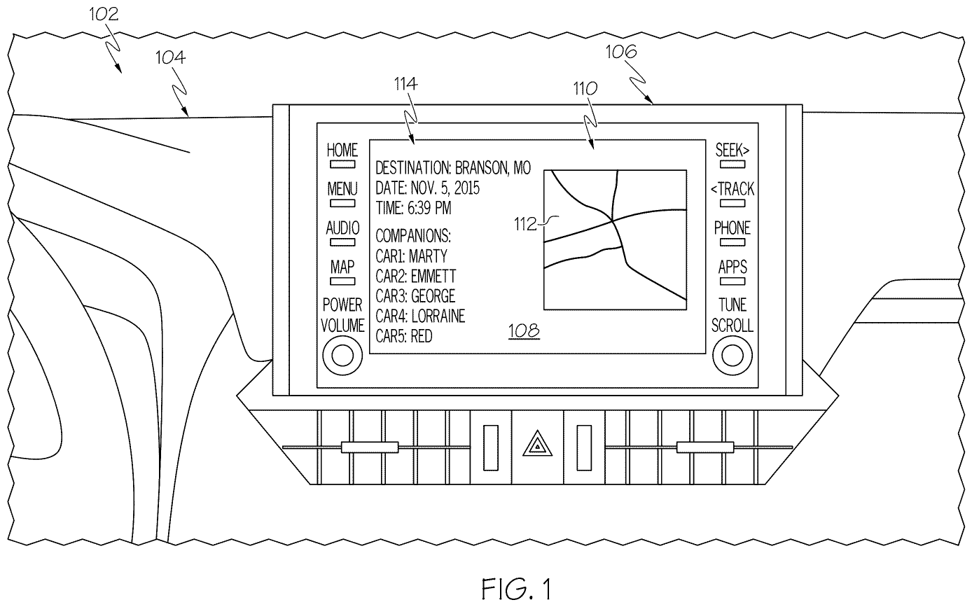

Referring now to FIG. 1, an interior 104 of an example vehicle 102 is illustrated. The interior 104 includes an input device, which in the illustrated embodiment is a head unit 106 having an electronic display 108 that displays a user interface 110. The electronic display 108 may be touch-sensitive such that a user may touch soft-buttons in the user interface 110. It should be understood that the vehicle 102 may include other input devices, such as one or more microphones that a user may speak into to provide voice input into the vehicle 102.

The user interface 110 is used to perform at least some of the functionalities described herein. It should be understood that the user interface 110 illustrated by FIG. 1 is provided for illustrative purposes only, and embodiments may take on many different configurations for the user interface 110. The user interface 110 enables a user (e.g., a driver or a passenger) of the vehicle 102 develop a route for the vehicle 102 and one or more companion vehicles. The systems and methods described herein aid in companions arriving at one or more common destinations at the same time. The companions may be family and or friends that are taking a leisure trip to a common destination using multiple vehicles with different origination locations. As another example, the companions may be military personnel that are attempting to achieve a common goal. As yet another example, the companions may be emergency personnel (e.g., rescue squad) attempting to reach a common location for a rescue. Embodiments may be utilized for any type of companions or situations, using any vehicle type (e.g., cars, trucks, vans, busses, aircraft, and watercraft).

The user interface 110 enables a user to enter inputs 114 in the form of details regarding a desired trip or other goal. The inputs 114 may be the destination location, the date and time of arrival, any stops or waypoints along the way, driving preferences, such as daylight only driving hours, highway avoidance, toll road avoidance, and any other preferences or details for the trip. The inputs 114 also allow a user to input one or more companions in one or more companion vehicles. As described in more detail below, embodiments of the present disclosure enable a primary vehicle and one or more companion vehicles to arrive at a destination location, as well as one or more stops or waypoints, at substantially the same time. As used herein, the phrase “substantially the same time” means within a hour of one another. The primary vehicle 102 may receive location data from the selected one or more companion vehicles. As one example, the one or more companion vehicles may send telematics data, such as location, speed, and any other relevant vehicle data. As another example, the location data and speed data may be provided by a companion's mobile device, such as a smart phone. With the location of the vehicle and the companion locations of the one or more companion vehicles known, the system develops routes for the primary vehicle 102 as well as the one or more companion vehicles. Additionally, the primary vehicle 102 may send route information and one or more control signals to control the companion vehicles such that they all arrive at the destination location at substantially the same time.

The route information can be in the form of an indication as to when the companion should start the trip, the roads the companion should travel, the speed in which the companion vehicle should travel, and the stops that the companion vehicle should make. The route information may be provided on the head unit of the companion vehicle, in a mobile device application, an email, a text message, or any other form of conveying information.

The control signals may be in the form of wireless control signals that cause the companion vehicle to perform certain actions. As a non-limiting example, when the companion vehicle is driving using a cruise control feature, the control signals may cause the maximum speed setting to slow down or speed up so that the companion vehicle remains on track to reach the destination location at the desired date and time. As another non-limiting example, in a semi-autonomous driving mode, the control signals may cause the companion vehicle to change lanes, or take an exit off of the highway. As another non-limiting example, in a fully autonomous driving mode, the control signals provided to the companion vehicle may cause the companion vehicle to autonomously perform maneuvers such that it arrives at the same time as the primary vehicle 102 and any other companion vehicles.

Still referring to FIG. 1, the user is planning a trip for family and friends to Branson, Missouri to take in some shows, enjoy fine dining, do some hiking, and go to an amusement park. The family and friends of the user are traveling in six different companion vehicles all from different locations. Normally it would be difficult to coordinate and plan how each of the vehicles to travel to meet at the destination at the same time. Using the systems of the present disclosure, the user enters the name of a companion into the inputs 114 of the user interface 110. In the present example, Marty is traveling in CAR1, Emmett is traveling in CAR2, George is traveling in CAR3, Lorraine is traveling in CAR4, and Red is traveling in CAR5.

In some embodiments, the users, such as Marty, Emmett and the like, are registered with the companion traveling system such that the primary vehicle 102 obtains the companion locations of the companion vehicles. As stated above, the companion locations may come from companion vehicle telematics data or from a companion's mobile device. In cases where the companion location data is unavailable, the user may manually enter the companion location of the particular companion vehicle.

The user interface 110 may also include a map 112 that shows a view of the destination location as well as the location of the primary vehicle 102, a location of the companion vehicles, and the route that each vehicle of the group will travel.

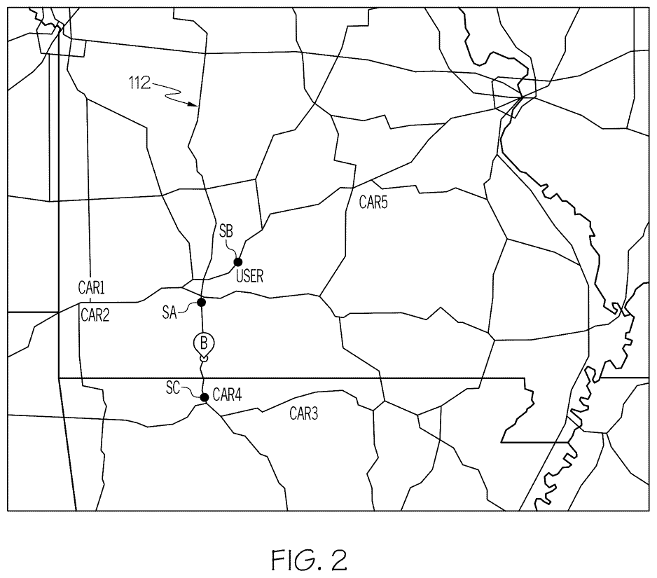

FIG. 2 illustrates an example map 112 in greater detail. According to the map, the user's location is northeast of Springfield, Missouri (indicated as USER). CAR1 and CAR2, driven by Marty and Emmett, respectively, are starting their trips from Joplin, Missouri. CAR3 driven by George is starting in Mountain Home Arkansas, while CAR4 is starting in Harrison, Arkansas. CAR5 driven by Red is beginning the trip in Rolla, Missouri. The system automatically generates routes for all of the vehicles involved in the trip, as well as start times for each vehicle. Guidance as to average speed may also be provided.

Additionally, one or more stops may be automatically generated. These stops may be generated using user-preferences of the user and/or one or more of the companions. For example, one companion may have a profile that indicates a preference of wanting to stop every hour to use the restroom, while another companion may have a profile that indicates a preference of stopping at noon for a roast beef sandwich with horseradish sauce. The routes generated by the system will include the preferences an generate an itinerary so that each vehicle in the group will arrive at the destination location at substantially the same time.

As shown in FIG. 2, the routes include several stops for the vehicles within the travelling caravan. For example, stop SA is located near Springfield, Missouri. This stop may be visited by several companion vehicles, such as CAR1 and CAR2. Stop SB is located at the user's originating location northeast of Springfield, and may be visited by CAR5 driven by Red. For example, Red may drive to stop SB and both the user and Red may travel from stop SB toward Branson, Missouri. As a further example, the system may route CAR1, CAR2, CAR5 and the user such that they all meet at stop SA and then continue to Branson.

Stop SC is located at the starting location of companion vehicle CAR4 driven by Lorraine. Like the user and CAR5 with respect to stop SB, CAR3 driven by George may meet Lorraine at stop SC such that Lorraine starts her trip with George.

It should be understood that the various companion vehicles, routes, and stops shown in FIG. 2 and described herein are merely used as examples, and that any number of vehicles, stops, routes and destinations may be utilized.

In some embodiments, the user or a companion may indicate that they need to make an unplanned stop. This information may be wirelessly transmitted to the primary vehicle 102, which may then update the route of the affected companion vehicle and/or the routes of the other companion vehicles such that all of the vehicles arrive at the destination at approximately the same time. In some cases, the arrival time may be adjusted. As another example, the system may produce one or more stops for the other vehicles in the group to accommodate the time needed by the companion (or user) that needs to make an unplanned stop.

The individual routes may be generated by any known or yet-to-be-developed route planning methods. For example, a traditional shortest-path or shortest time route planning algorithm may be modified to allow for the optimizing of multiple routes for each start and end point in such a way that all companions converge at the destination at substantially the same time. A vehicle routing problem (VRP) may also be utilized to expand the shortest-path problem to multiple vehicles, optimizing routes while considering constraints such as delivery window, fuel-consumption, and driver schedules. For example, the routing algorithm may take into consideration the fuel economy or efficiency of a vehicle to determine when and how long a vehicle will need to stop to refuel or recharge. As another example, capacity-constrained routing may be used to allocate routes based on load balancing among multiple drivers. As another example, a game-theoretic approach may be utilized whereby driver behavior is modeled as a competitive environment where routing choices influence each other.

Data such as speed limits, traffic signals, historical travel times, shortcuts, crowdsourced information may all be utilized when developing and updating optimized routes for the individual vehicles. Machine learning may be used to predict congestion patterns. Additionally, Personalized routing preferences of a user may be used to refine route suggestions (e.g., avoid tolls, avoid highways).

As another example, a trained model may be used to generate the routes. For example, a large-language model such as GPT 3.5/4.0 may be used to generate the routes. The input parameters (e.g., user location, companion vehicle locations, destination, destination date and time, and any other requirements) may be added to a prompt that is provided to the large-language model, which then outputs a plurality of routes and information regarding the trip. In some embodiments, a custom-build LLM is developed and used to generate routes for individual vehicles from the lead vehicle in the platoon, or from a remote location such as the cloud. Operating the LLM at a remote location will lessen the computational abilities of the lead vehicle.

The locations of all of the vehicles in the group are continuously monitored. The route information and/or control systems may be updated based on real-time location data. For example, one companion driver may be driving slowing or in traffic, and the system may create one or more stops for the other vehicles in the group, or instruct the other vehicles to slow down.

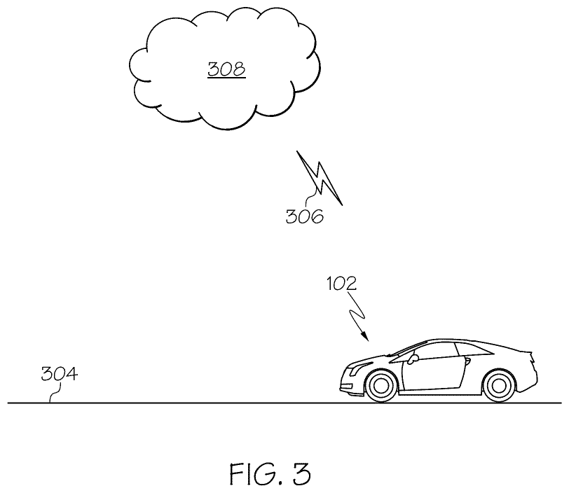

As stated above, the primary vehicle 102 may transmit wireless control signals to the companion vehicle(s) such that all of the vehicles arrive at the destination location at substantially the same time. FIG. 3 illustrates the vehicle 102 driving on a road 304. Wireless control signals 306 are transmitted to and from the companion vehicles over a wireless communication network 308. The wireless communication network 308 may be any type of communication network, such as a cellular network, a WiFi network, a vehicle-to-vehicle (V2V) mesh network, a vehicle-to-anything (V2X) network, and a satellite network. These control signals may control components of the companion vehicle(s), such as acceleration, braking, steering and any other motion controls. The control signals 306 may be tailored to the capabilities of the particular vehicles. In some cases, the control signals may set cruise control speeds, while in other cases the control signals may provide autonomous driving maneuvers.

It is noted that, although embodiments of the present disclosure describe the primary vehicle 102 as generating control signals and route information, these tasks may be performed by a remote computer in a cloud computing environment.

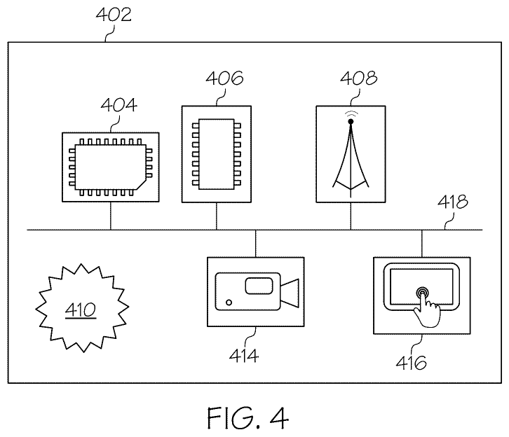

FIG. 4 depicts an example vehicle system 402 included in the vehicle 102 of FIG. 1. The vehicle system 402 includes one or more processors 404, a network interface hardware 408, a drivetrain 410 (e.g., an electric motor and associated components or an internal combustion engine and associated components), one or more vehicle sensors 414, network interface hardware 408, and one or more input/output devices 416, the details of which will be set forth in the following paragraphs. The vehicle system 402 may also include one or more modules for performing autonomous driving of the vehicle 102. These modules are not shown in FIG. 4 for brevity. It should be understood that the vehicle system 402 of FIG. 4 is provided for illustrative purposes only, and that other vehicle systems 402 comprising more, fewer, or different components may be utilized.

Each of the one or more processors 404 may be any device capable of executing machine readable and executable instructions. Accordingly, each of the one or more processors 404 may be a controller, an integrated circuit, a microchip, a computer, or any other computing device. The one or more processors 404 are coupled to a communication path 418 that provides signal interconnectivity between various modules of the vehicle system 402. Accordingly, the communication path 418 may communicatively couple any number of processors 404 with one another, and allow the modules coupled to the communication path 418 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 418 may be formed from any medium that is capable of transmitting a signal such as, for example, conductive wires, conductive traces, optical waveguides, or the like. In some embodiments, the communication path 418 may facilitate the transmission of wireless signals, such as WiFi, Bluetooth®, Near Field Communication (NFC) and the like. Moreover, the communication path 418 may be formed from a combination of mediums capable of transmitting signals. In one embodiment, the communication path 418 comprises a combination of conductive traces, conductive wires, connectors, and buses that cooperate to permit the transmission of electrical data signals to components such as processors, memories, sensors, input devices, output devices, and communication devices. Accordingly, the communication path 418 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 402 includes one or more memory components 406 coupled to the communication path 418. The one or more memory components 406 may comprise RAM, ROM, flash memories, hard drives, or any device capable of storing machine readable and executable instructions such that the machine readable and executable instructions can be accessed and executed by the one or more processors 404. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory components 406. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The functionalities described herein, including receiving user inputs, receiving companion vehicle locations, generating and updating routes, and sending route information and control signals, may be provided in one or more logic modules stored within the one or more memory modules 406.

The vehicle system 402 comprises one or more vehicle sensors 414. Each of the one or more vehicle sensors 414 is coupled to the communication path 418 and communicatively coupled to the one or more processors 404. The one or more vehicle sensors 414 may include, but are not limited to, LiDAR sensors, RADAR sensors, optical sensors (e.g., cameras, laser sensors, proximity sensors), location sensors (e.g., global positioning system modules) and the like. The vehicle sensors 414 may be used to navigate the autonomous vehicle 102, and provide and receive data to and from the companion vehicles.

Still referring to FIG. 4, the vehicle system 402 comprises network interface hardware 408 for communicatively coupling the vehicle system 402 to the remote computing device 104. The network interface hardware 408 can be communicatively coupled to the communication path 418 and can be any device capable of transmitting and/or receiving data via a network. Accordingly, the network interface hardware 408 can include a communication transceiver for sending and/or receiving any wired or wireless communication. For example, the network interface hardware 408 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 408 includes hardware configured to operate in accordance with the Bluetooth® wireless communication protocol. The network interface hardware 408 is configured to transmit and receive signals, such as control signals, route information, traffic data, location information, and any other data, over a wireless communication network.

In some embodiments, the vehicle system 402 may be communicatively coupled to a remote computing device 104 (not shown) by a wireless communication network 308 (FIG. 3). In one embodiment, the network may include one or more computer networks (e.g., a personal area network, a local area network, or a wide area network), cellular networks, satellite networks and/or a global positioning system and combinations thereof. Accordingly, the vehicle system 402 can be communicatively coupled to the network via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

The vehicle system 402 includes a drivetrain 410 that includes components capable of performing motive control of the vehicle 102. The drivetrain 410 may be an electric motor, battery pack, and inverter system as a non-limiting example. The drivetrain 410 may also be an internal combustion engine, or a hybrid electric/internal combustion engine. The drivetrain 410 receives inputs from the driver, as well as an autonomous driving system, if equipped.

The vehicle system 402 also includes one or more input/output devices 416 for receiving input and/or displaying outputs. The one or more input/output devices 416 may include a touch screen, knobs, buttons, switches, electronic displays, microphones, haptic feedback devices, speakers, and any other devices capable of receiving inputs and/or producing outputs. The one or more input/output devices 416 may be configured to receive the inputs described herein, as well as produce outputs such as route information and other messages regarding a caravan.

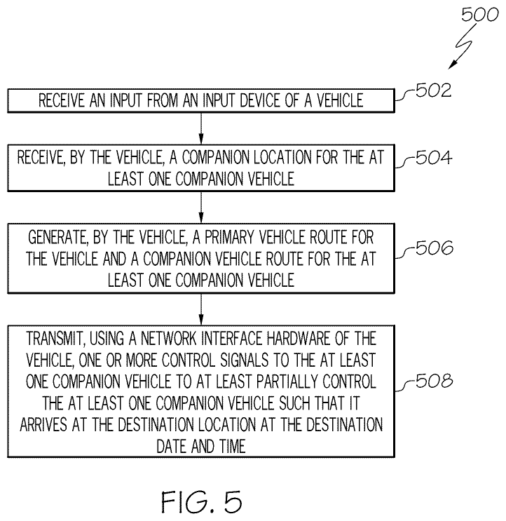

FIG. 5 illustrates an example method 500 for routing and controlling a plurality of vehicles. In block 502, the method 500 receives an input from an input device of a vehicle. The input includes a destination location, a destination date and time, and at least one companion vehicle. In block 504, the method 500 receives, by the vehicle, a companion location for the at least one companion vehicle. In block 506, the method 500 generates, by the vehicle, a primary vehicle route for the vehicle and a companion vehicle route for the at least one companion vehicle. In block 508, method 500 transmits, using a network interface hardware of the vehicle, one or more control signals to the at least one companion vehicle to at least partially control the at least one companion vehicle such that it arrives at the destination location at the destination date and time.

It should now be understood that embodiments of the present disclosure provide systems and methods for coordinating a plurality of vehicles such that they arrive at a destination at the substantially the same time, or achieve some other objective. More particularly, embodiments of the present disclosure enable a primary, lead vehicle to generate routes for a plurality of companion vehicles of a caravan, platoon or other group. In some embodiments, a lead vehicle or remote computing device may provide control signals to the other companion vehicles. The companion vehicles may be manually controlled, semi-autonomously controlled, or autonomously controlled. The vehicles in the caravan, platoon or other group may be traveling to a common location from many individual origination locations.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
an input device;
a network interface hardware;
one or more processors;
a non-transitory memory component storing instructions that, when executed by the one or more processors, cause the one or more processors to:
receive an input from the input device, the input comprising:
a destination location;
a destination date and time; and
at least one companion vehicle;
receive a companion location for the at least one companion vehicle;
generate a primary vehicle route for the vehicle and a companion vehicle route for the at least one companion vehicle; and
transmit, using the network interface hardware, one or more control signals to the at least one companion vehicle to at least partially control the at least one companion vehicle such that it arrives at the destination location at the destination date and time.

2. The vehicle of claim 1, wherein the instructions further cause the one or more processors to generate one or more control signals to at least partially control the vehicle such that it arrives at the destination location at the destination date and time.

3. The vehicle of claim 2, wherein the instructions further cause the one or more processors to continuously determine a location of the vehicle and the companion location for the at least one companion vehicle, and adjust the one or more control signals provided to the vehicle and the one or more control signals provided to the at least one companion vehicle as needed.

4. The vehicle of claim 1, wherein the instructions further cause the one or more processors to transmit, using the network interface hardware, an itinerary to the at least one companion vehicle.

5. The vehicle of claim 1, wherein the primary vehicle route and the companion vehicle route each comprise at least one stop and the one or more control signals to the at least one companion vehicle and the one or more control signals to the vehicle are such that the vehicle and the at least one vehicle arrive at the destination location at substantially the same time.

6. The vehicle of claim 1, wherein the instructions further cause the one or more processors to:
receive a waypoint destination from the input device; and
update the primary vehicle route and the companion vehicle route.

7. The vehicle of claim 1, wherein the instructions further cause the one or more processors to transmit, using the network interface hardware, at one or more control signals to the companion vehicle and one or more control signals for the vehicle such that the vehicle and the at least one companion vehicle arrive at the waypoint destination at substantially the same time.

8. The vehicle of claim 1, wherein the primary vehicle route includes one or more stops that are not visited by the at least one companion vehicle.

9. The vehicle of claim 1, wherein the at least one companion vehicle comprises two or more companion vehicles.

10. The vehicle of claim 1, wherein a location of the vehicle and the companion location are separated by a geodesic distance greater than or equal to 100 km.

11. A method for routing a plurality of vehicles, the method comprising:
receiving an input from an input device of a vehicle, the input comprising:
a destination location;
a destination date and time; and
at least one companion vehicle;
receiving, by the vehicle, a companion location for the at least one companion vehicle;
generating, by the vehicle, a primary vehicle route for the vehicle and a companion vehicle route for the at least one companion vehicle; and
transmitting, using a network interface hardware of the vehicle, one or more control signals to the at least one companion vehicle to at least partially control the at least one companion vehicle such that it arrives at the destination location at the destination date and time.

12. The method of claim 11, further comprising generating one or more control signals to at least partially control the vehicle such that it arrives at the destination location at the destination date and time.

13. The method of claim 12, further comprising continuously determining a location of the vehicle and the companion location for the at least one companion vehicle, and adjusting the one or more control signals provided to the vehicle and the one or more control signals provided to the at least one companion vehicle as needed.

14. The method of claim 11, further comprising transmitting, using the network interface hardware, an itinerary to the at least one companion vehicle.

15. The method of claim 11, wherein the primary vehicle route and the companion vehicle route each comprise at least one stop and the one or more control signals to the at least one companion vehicle and the one or more control signals to the vehicle are such that the vehicle and the at least one vehicle arrive at the destination location at substantially the same time.

16. The method of claim 11, further comprising:
receiving a waypoint destination from the input device; and
updating the primary vehicle route and the companion vehicle route.

17. The method of claim 11, further comprising, using the network interface hardware, at one or more control signals to the companion vehicle and one or more control signals for the vehicle such that the vehicle and the at least one companion vehicle arrive at the waypoint destination at substantially the same time.

18. The method of claim 11, wherein the primary vehicle route includes one or more stops that are not visited by the at least one companion vehicle.

19. The method of claim 11, wherein the at least one companion vehicle comprises two or more companion vehicles.

20. The method of claim 11, wherein a location of the vehicle and the companion location are separated by a geodesic distance greater than or equal to 100 km.
